(19) United States
(12) Patent Application Publication
(10) Pub. No.: US 2004/0001487 A1
(43) Pub. Date: Jan. 1, 2004

(54) Programmable InfiniBand switch

(76) Inventors: S. Paul Tucker, F. Collins, CO (US); Edmundo Rojas, Fort Collins, CO (US); Mercedes E. Gil, Fort Collins, CO (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/186,038

(22) Filed: Jun. 28, 2002

(51) Int. Cl. H04L 12/28

(52) U.S. Cl. 370/389; 370/400

(57) ABSTRACT

A switch for use with an InfiniBand network. The switch includes a crossbar that redirects packet based data based on a forwarding table. At least one port that receives data from a network and selectively transfers that data to the crossbar at 1×, 4×, and 12× speeds. A state machine that controls the changing of the speed of operation of the port.

### BACKGROUND OF THE INVENTION

InfiniBand™ is an emerging bus technology that hopes to replace the current PCI bus standard, which only supports up to 133 Mbps (Megabits per second) transfers, with a broader standard that supports a maximum shared bandwidth of 566 Mbps. InfiniBand is the culmination of the combined efforts of about 80 members that are led by Intel, Compaq, Dell, Hewlett-Packard, IBM, Microsoft and Sun Systems who collectively call themselves the InfiniBand Trade Association. The InfiniBand Trade Association has published a specification entitled: Infiniband™ Architecture Specification Release 1.0. The Specification spans three volumes and is incorporated herein by reference.

The InfiniBand Architecture (referred to herein as “IBA”) is a first order interconnect technology, independent of the host operating system (OS) and processor platform, for interconnecting processor nodes and I/O nodes to form a system area network. IBA is designed around a point-to-point, switched I/O fabric, whereby end node devices (which can range from very inexpensive I/O devices like single chip SCSI or Ethernet adapters to very complex host computers) are interconnected by cascaded switch devices. The physical properties of the IBA interconnect support two predominant environments:

i. Module-to-module, as typified by computer systems that support I/O module add-in slots

ii. Chassis-to-chassis, as typified by interconnecting computers, external storage systems, and external LAN/WAN access devices (such as switches, hubs, and routers) in a data-center environment.

IBA supports implementations as simple as a single computer system, and can be expanded to include: replication of components for increased system reliability, cascaded switched fabric components, additional I/O units for scalable I/O capacity and performance, additional host node computing elements for scalable computing, or any combinations thereof. IBA is scalable to enable computer systems to keep up with the ever-increasing customer requirement for increased scalability, increased bandwidth, decreased CPU utilization, high availability, high isolation, and support for Internet technology. Being designed as a first order network, IBA focuses on moving data in and out of a node's memory and is optimized for separate control and memory interfaces. This permits hardware to be closely coupled or even integrated with the node's memory complex, removing any performance barriers.

IBA uses reliable packet based communication where messages are enqueued for delivery between end nodes. IBA defines hardware transport protocols sufficient to support both reliable messaging (send/receive) and memory manipulation semantics (e.g. remote DMA) without software intervention in the data movement path. IBA defines protection and error detection mechanisms that permit IBA transactions to originate and terminate from either privileged kernel mode (to support legacy I/O and communication needs) or user space (to support emerging interprocess communication demands).

IBA can support bandwidths that are anticipated to remain an order of magnitude greater than current I/O media (SCSI, Fiber Channel, and Ethernet). This enables IBA to act as a common interconnect for attaching I/O media using these technologies. To further ensure compatibility across varying technologies, IBA uses IPv6 headers, supporting extremely efficient junctions between IBA fabrics and traditional Internet and Intranet infrastructures.

FIG. 1 is a block diagram of the InfiniBand architecture layers 100. IBA operation can be described as a series of layers 100. The protocol of each layer is independent of the other layers. Each layer is dependent on the service of the layer below it and provides service to the layer above it.

The physical layer 102 specifies how bits are placed on a wire to form symbols and defines the symbols used for framing (i.e., start of packet & end of packet), data symbols, and fill between packets (Idles). It specifies the signaling protocol as to what constitutes a validly formed packet (i.e., symbol encoding, proper alignment of framing symbols, no invalid or non-data symbols between start and end delimiters, no disparity errors, synchronization method, etc.).

The link layer 104 describes the packet format and protocols for packet operation, e.g. flow control and how packets are routed within a subnet between the source and destination. There are two types of packets: link management packets and data packets.

Link management packets are used to train and maintain link operation. These packets are created and consumed within the link layer 104 and are not subject to flow control. Link management packets are used to negotiate operational parameters between the ports at each end of the link such as bit rate, link width, etc. They are also used to convey flow control credits and maintain link integrity.

Data packets convey IBA operations and can include a number of different headers. For example, the Local Route Header (LRH) is always present and it identifies the local source and local destination ports where switches will route the packet and also specifies the Service Level (SL) and Virtual Lane (VL) on which the packet travels. The VL is changed as the packet traverses the subnet but the other fields remain unchanged. The Global Route Header (GRH) is present in a packet that traverses multiple subnets. The GRH identifies the source and destination ports using a port's Global ID (GID) in the format of an IPv6 address.

There are two CRCs in each packet. The Invariant CRC (ICRC) covers all fields which should not change as the packet traverses the fabric. The Variant CRC (VCRC) covers all of the fields of the packet. The combination of the two CRCs allow switches and routers to modify appropriate fields and still maintain an end to end data integrity for the transport control and data portion of the packet. The coverage of the ICRC is different depending on whether the packet is routed to another subnet (i.e. contains a global route header).

The network layer 106 describes the protocol for routing a packet between subnets. Each subnet has a unique subnet ID, the Subnet Prefix. When combined with a Port GUID, this combination becomes a port's Global ID (GID). The source places the GID of the destination in the GRH and the LID of the router in the LRH. Each router forwards the packet through the next subnet to another router until the packet reaches the target subnet. Routers forward the packet based on the content of the GRH. As the packet traverses different subnets, the routers modify the content of the GRH and replace the LRH. The last router replaces the LRH using the LID of the destination. The source and destination GIDs do not change and are protected by the ICRC field. Routers recalculate the VCRC but not the ICRC. This preserves end to end transport integrity.

While, the network layer 106 and the link layer 104 deliver a packet to the desired destination, the transport layer 108 is responsible for delivering the packet to the proper queue pair and instructing the queue pair how to process the packet's data. The transport layer 108 is responsible for segmenting an operation into multiple packets when the message's data payload is greater than the maximum transfer unit (MTU) of the path. The queue pair on the receiving end reassembles the data into the specified data buffer in its memory.

IBA supports any number of upper layers 110 that provide protocols to be used by various user consumers. IBA also defines messages and protocols for certain management functions. These management protocols are separated into Subnet Management and Subnet Services.

FIG. 2 is a block diagram of an InfiniBand subnet 200. An IBA subnet 200 is composed of endnodes 202, switches 204, a subnet manager 206 and, possibly one or more router(s) 208. Endnodes 202 may be any one of a processor node, an I/O node, and/or a router (such as the router 208). Switches 202 are the fundamental routing component for intra-subnet communication. The switches 202 interconnect endnodes 202 by relaying packets between the endnodes 202. Routers 208 are the fundamental component for inter-subnet communication. Router 208 interconnects subnets by relaying packets between the subnets.

Switches 204 are transparent to the endnodes 202, meaning they are not directly addressed (except for management operations). Instead, packets transverse the switches 204 virtually unchanged. To this end, every destination within the subnet 200 is configured with one or more unique local identifiers (LID). From the point of view of a switch 204, a LID represents a path through the switch. Packets contain a destination address that specifies the LID of the destination. Each switch 204 is configured with forwarding tables (not shown) that dictate the path a packet will take through the switch 204 based on a LID of the packet. Individual packets are forwarded within a switch 204 to an out-bound port or ports based on the packet's Destination LID and the Switch's 204 forwarding table. IBA switches support unicast forwarding (delivery of a single packet to a single location) and may support multicast forwarding (delivery of a single packet to multiple destinations).

The subnet manager 206 configures the switches 204 by loading the forwarding tables into each switch 204. To maximize availability, multiple paths between endnodes may be deployed within the switch fabric. If multiple paths are available between switches 204, the subnet manager 206 can use these paths for redundancy or for destination LID based load sharing. Where multiple paths exists, the subnet manager 206 can re-route packets around failed links by re-loading the forwarding tables of switches in the affected area of the fabric.

FIG. 3 is a block diagram of an InfiniBand Switch 300. IBA switches, such as the switch 300, simply pass packets along based on the destination address in the packet's LRH. IBA switches do not generate or consume packets (except for management packets). Referring to

FIG. 1, IBA switches interconnect the link layers 104 by relaying packets between the link layers 104.

In operation the switch 300 exposes two or more ports 302a, 302b . . . 302n, between which packets are relayed. Each port 302n communicates with a packet relay 304 via a set of virtual lanes 306a though 306n. The packet relay 304 (sometimes referred to as a “hub” or “crossbar”) redirects the packet to another port 302, via that port's associated with virtual lanes 306, for transmission based on the forwarding table associated with the packet relay 304.

IBA provides for switch operation at 1×, 4× or 12× speeds, however, the IBA specification provides very few directives regarding the implementation of the various speeds, other than specifying a byte in a management packet for selecting the speed. Accordingly, the present Inventors have recognized a need for apparatus and methods for switching the operation speed of an IBA switch, which minimize hardware requirements while minimizing the amount of cycles that such a switch over takes.

### BRIEF DESCRIPTION OF THE DRAWINGS

An understanding of the present invention can be gained from the following detailed description of the invention, taken in conjunction with the accompanying drawings of which:

FIG. 1 is a block diagram of the InfiniBand architecture layers.

FIG. 2 is a block diagram of an InfiniBand subnet.

FIG. 3 is a block diagram of an InfiniBand switch.

FIG. 4 is a block diagram of an InfiniBand switch in accordance with a preferred embodiment of the present invention.

FIG. 5 is a block diagram of an InfiniBand switch in accordance with a preferred embodiment of the present invention.

FIG. 6 is a block diagram of an InfiniBand switch in accordance with a preferred embodiment of the present invention.

FIG. 7 is a diagram of a state machine used in a preferred embodiment of the present invention.

FIG. 8 is a block diagram of an InfiniBand switch in accordance with a preferred embodiment of the present invention.

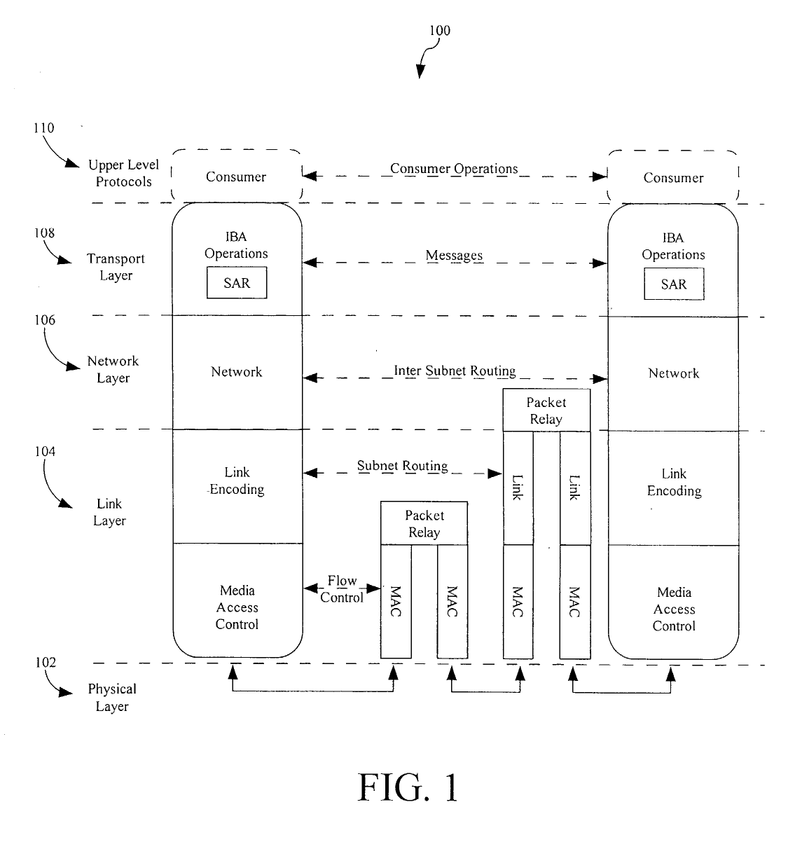

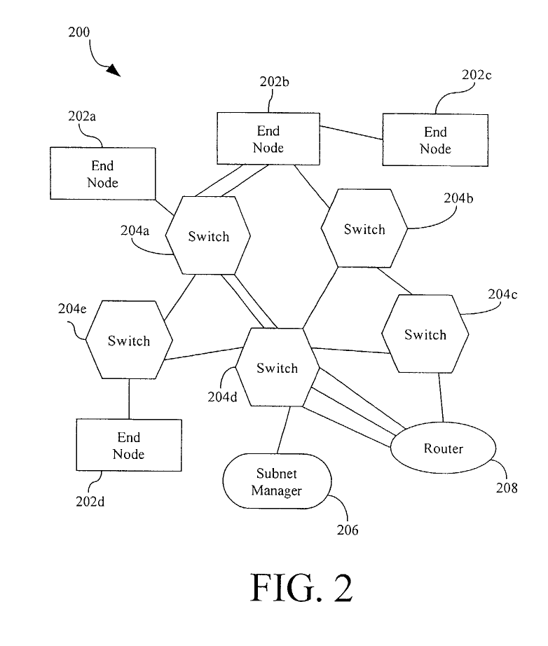

### DETAILED DESCRIPTION

Reference will now be made in detail to the present invention, examples of which are illustrated in the accompanying drawings, wherein like reference numerals refer to like elements throughout.

In general, the present invention relates to apparatus and method steps embodied in software and associated hardware including computer readable medium, configured to store and/or process electrical or other physical signals to generate other desired signals. In general, the method steps require physical manipulation of data representing physical quantities. Usually, though not necessarily, such data takes the form of electrical or magnetic signals capable of being stored, transferred, combined, compared or otherwise manipulated. Those of ordinary skill in the art conveniently refer to these signals as “bits”, “values”, “elements”, “symbols”, “characters”, “images”, “terms”, “numbers”, or the like. It should be recognized that these and similar terms are to be associated with the appropriate physical quantities they represent and are merely convenient labels applied to such quantities.

Accordingly, the detailed description which follows contains descriptions of methods presented in terms of methods that are described using symbolic representations of data transfixed in a computer readable medium such as RAM, ROM, CR-ROM, DVD, hard disk, floppy disk, data communication channels such as USB, SCSI, or FIREWIRE and/or a network such as IBA, the Internet, or a LAN. These descriptions and representations are the means used by those skilled in the art effectively convey the substance of their work to others skilled in the art.

The term data processing device encompasses any of a variety of devices that are responsive to data and either perform some operation in response to the receipt thereof or modify the data in accordance with internal or external instructions that may be stored separately from the data processing devices or encoded into the structure of the data processing device. The term “method” is generally used to refer to a series of operations performed by a data processing device and, as such, encompasses such terms of art as “routine,” “software,” “program,” “objects,” “functions,” “subroutines,” and “procedures.”

Unless otherwise noted, the methods recited herein may be enabled in one or more integrated circuits configured to perform the method steps taught herein. The required functional structures for such circuits appear in the description given below. Data processing devices that may be configured to perform the functions of the present invention include those manufactured by such companies as AGILENT and CISCO as well as other manufacturers of networking devices.

FIG. 4 is a conceptual block diagram of a switch 400 in accordance with the preferred embodiment of the present invention. It will be appreciated by those of ordinary skill in the relevant arts that the switch 400, as illustrated in FIG. 4, and the operation thereof as described hereinafter is intended to be generally representative of such systems and that any particular switch may differ significantly from that shown in FIG. 4, particularly in the details of construction and operation. As such, the switch 400 is to be regarded as illustrative and exemplary and not limiting as regards the invention described herein or the claims attached hereto.

The switch 400 generally comprises a crossbar 402 (also referred to as a “hub”) to which a plurality of ports 404a through 404h are connected. Each port 404 of the switch 400 generally comprises a link block 406 and a physical block 408 (“PHY”). In perhaps the preferred embodiment the crossbar 402 is a ten port device with two ports being reserved for management functions. FIG. 4 only portrays eight ports 404a through 404h for clarity of presentation.

The PHY block 408 primarily serves as a serialize to de-serialize (“SerDes”) device. The link block 406 performs several functions, including the input buffer, receive (“RX”), transmit (“TX”), and flow control. The input virtual lanes (VLs) are physically contained in input buffers (not shown) of the link block 406. Other functions that may be performed by the link block 406 include: integrity checking, link state and status, error detecting and recording, flow control generation, and output buffering.

The crossbar 402 is preferably implemented as a sparsely populated data path structure. In essence, the crossbar 402 acts as a distributed MUX for every possible input to each output port. The crossbar 402 is preferably combinatorial, and capable of completing the switching process for one 32-bit word within one 250 MHz system clock period (4.0 ns).

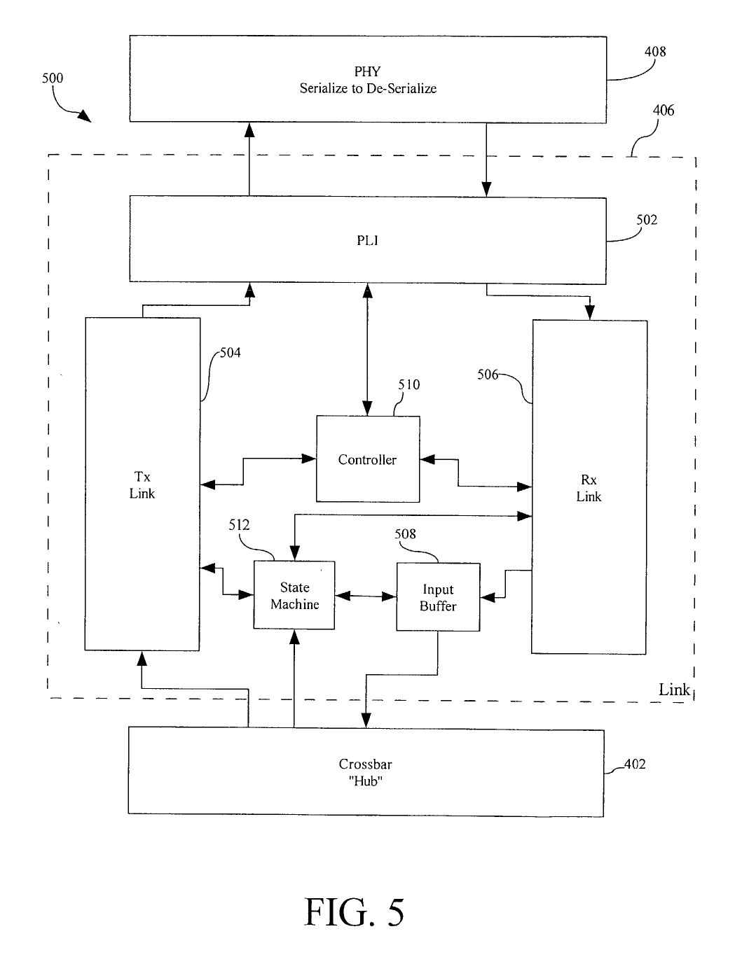

FIG. 5 is a block diagram of an InfiniBand switch 500 in accordance with a preferred embodiment of the present invention. More specifically, FIG. 5 is a more detailed view of the switch 400 shown in FIG. 4 providing more detail of the link block 406. The link block 406 generally comprises a phy-link interface 502 (the “PLI”) connected to a transmit link 504 (the “Tx Link”) and a receive link 506 (the “Rx Link”). The Rx link 506 outputs to an input buffer 508 for transfer of data to the crossbar 402. A controller 510, primarily comprising registers, controls the operation of transmit and receive links 504 and 506.

The PLI 502 connects transmitter and receiver portions of the PHY block 408 to the link block 406's Tx Link 504 and Rx Link 506. The receive portion of the PLI 502 realigns the data from the PHY block 408 and detects special characters and strings of characters, such as a start of packet (SOP) and end of packet (EOP) indicators, from the data stream. The PLI 502 transmits the special characters (and strings) to elements within the link 406 as required. With respect to packet delimiters, the PLI 502 provides these a single-bit, single -cycle signals, e.g. on for one state and off for the other state.

The Rx Link 506 accepts packet data from the PLI 502, performs certain checks, and passes the data on to the input buffer 508. The Tx Link 504 sends data packets that are ready to transfer from the Hub 402 to the PHY block 408, through the PLI 502. In doing so, the Tx Link 504 realigns the data, adds the placeholder for the start/end packet control characters, and calculates and inserts the VCRC field. In addition to data packets, the Tx Link 504 also accepts and transmits flow control link packets from a flow control state machine (not shown).

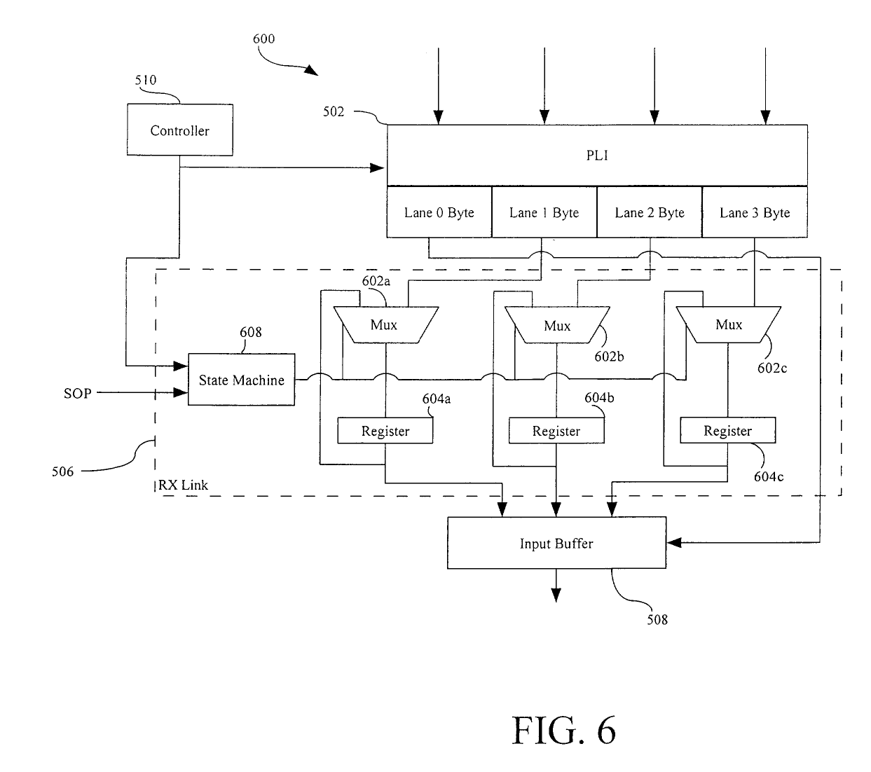

FIG. 6 is a block diagram of an InfiniBand switch 600 in accordance with a preferred embodiment of the present invention. More specifically, FIG. 6 is a more detailed view of the switch 500 shown in FIG. 5 providing additional detail of the Rx link 506. The Rx link 506 generally comprises a series of three multiplexers (“Mux”) 602a-c, coupled to a series of registers 604a-c. A state machine 608 controls the operation of the Mux's 602a-c.

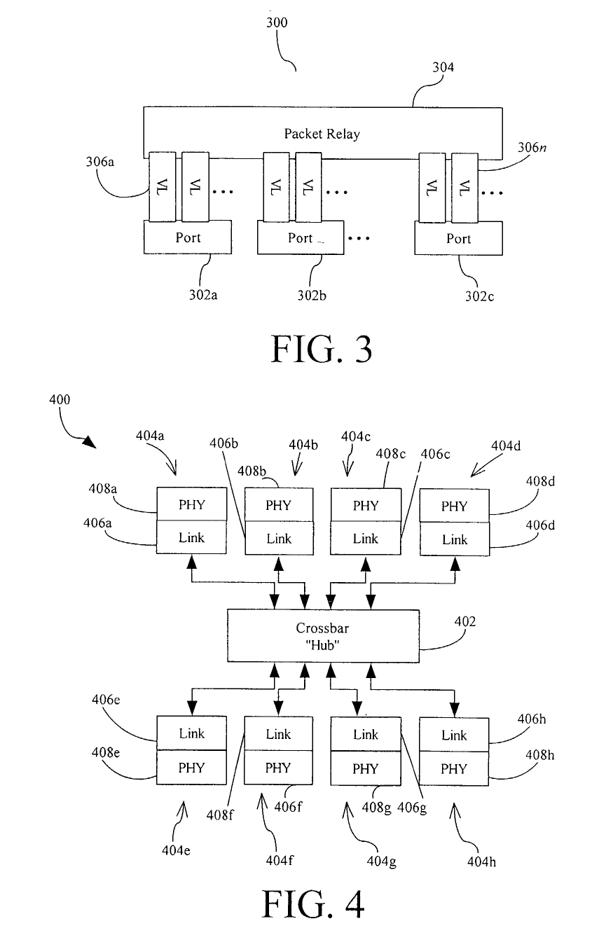

In general, the state machine 608 is responsive to values, indicating a desired speed of operation (1×, 4×, and 12×) set in registers in the controller 510 and controls the operation of the Rx link 506 accordingly. Those of ordinary skill in the art will recognize that while the switch shown in FIGS. 3 through 6 has been constructed for 1× and 4× operation, modification can be implemented to enable 12× operation.

In operation, serial data arrives at the PLI 502 from the PHY 408. The PLI 502 formats the data into four byte units on lanes 0-3. In 1× mode all four lanes contain the same byte, with a single byte arriving at every clock cycle. In 4× mode, the lanes each contain a different byte of the word, allowing a full word to arrive coincident with every clock cycle.

Functionally, the state machine 608 realigns the data from the PLI 502 based on the contents of registers in the controller 510 and on the presence of an SOP signal, indicating receipt of a start of packet indicator (as described in the IBA Specification, incorporated herein by reference). Practically, the state machine operates as a counter, and based on the content of the register in the controller 510, selects the output of the muxes 602 to be either the signal from the PLI 502 or the contents of the registers 604.

Upon receipt of an SOP signal, if registers in the controller 510 contain an indication that 4× mode is to be used, the lane 0 byte is first discarded (it would contain the SOP) and the first word's lane 1, lane 2 and lane 3 bytes are passed through the mux's 602a, 602b, and 602c into the registers 604a, 604b and 604c respectively. In a subsequent cycle, the lane 0 data is received for the first word and appended to the values in the registers 604a, 604b, and 604c in the input buffer 508. At the same time the lane 1, lane 2 and lane 3 data for the second word are passed through the muxes 602a-c into the registers 604. In the next cycle (the third from the start of this description) the lane 1, lane 2, and lane 3 data for the second word are combined with the lane 0 data received from the PLI 502 in the input buffer 508 and the third word's lane 1, lane 2 and lane 3 data are registered into the registers 604a-c.

The input buffer 508 is provided with the SOP delimiter and the 1×/4× mode bit. Accordingly, when a SOP is received, the input buffer 508 begins clocking the full 32-bit data word from the registers 604. If the 4× bit is set, the input buffer 508 captures data from the registers 604 every cycle. On the other hand, if the 1× bit is set, the input buffer 508 captures data from the registers 604 every fourth cycle.

If the register 510 contains an indication that the 1× mode is enabled then upon the receipt of a SOP the operation is as follows. The PLI 502 will copy the single received byte into each lane for each cycle. Therefore the RX Link 506 must preserve each byte as it is forwarded. In the first cycle, the lanes are flushed to remove the SOP. In the second cycle, the first words first byte is registered from lane 1 (into register 604a). In the third cycle, the first word's second byte is registered from lane two (into register 604b) while the lane 1 register value (in the register 604a) is fed back to the mux 602a under control of the state machine 608. In the fourth cycle the first word's third byte is registered from lane 3 (into register 604c) while the register values from lanes 1 and 2 are fed back to the mux's 604a and 604b, respectively, under control of the state machine 608. In the fifth cycle, the first words fourth byte is passed from lane 0 and combined with the values in the registers 604a, 604b, and 604c in the input buffer 508 to complete the first word. The process repeats for the remaining bytes in the packet.

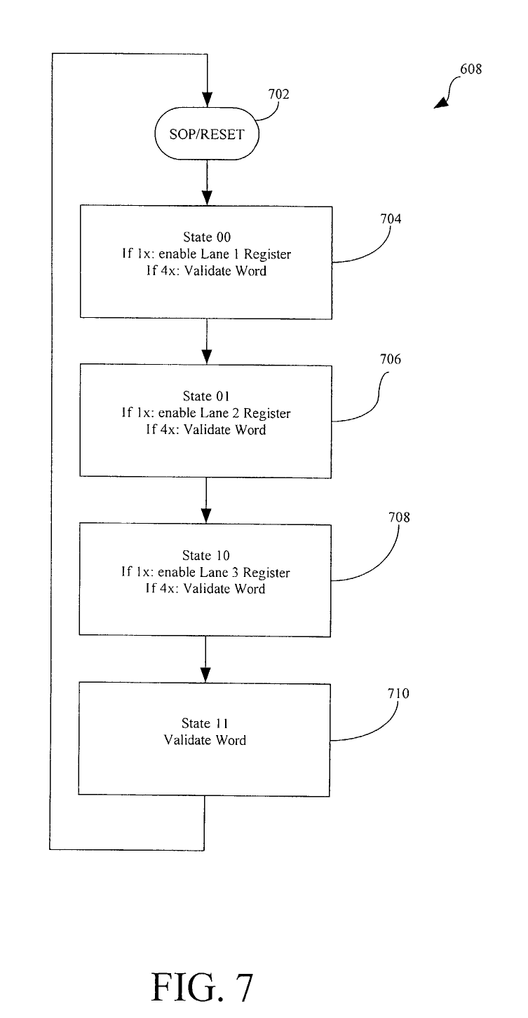

FIG. 7 is a diagram of the state machine 608 as used in a preferred embodiment of the present invention. The state machine starts operation upon the receipt of a SOP delimiter or a reset in step 702. Next, the state machine 608 enters state 00. If the 1× mode of operation is set, the state machine 608 enables feed back from the lane 1 register 604a. If the 4× mode of operation is set, the state machine 608 validates a word (the input buffer 508 is permitted to read a word). Next, the state machine 608 enters state 01. If the 1× mode of operation is set, the state machine 608 enables feed back from the lane 2 register 604b. If the 4× mode of operation is set, the state machine 608 validates a word. Next, the state machine 608 enters state 10. If the 1× mode of operation is set, the state machine 608 enables feed back from the lane 3 register 604c. If the 4× mode of operation is set, the state machine 608 validates a word. Next, the state machine 608 enters state 11 where, regardless of the 1×/4× mode, the state machine 608 validates a word.

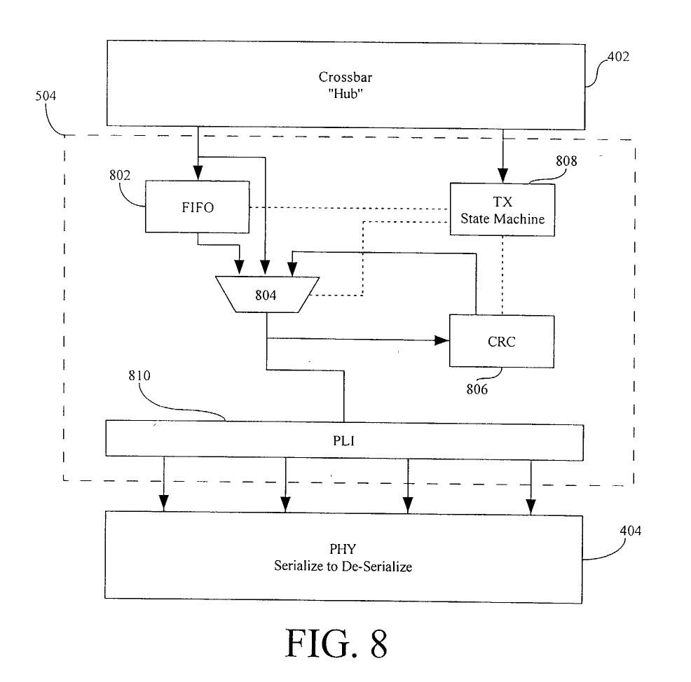

FIG. 8 is a block diagram an InfiniBand switch in accordance with a preferred embodiment of the present invention. More specifically, FIG. 6 is a more detailed view of the switch 500 shown in FIG. 5 providing additional detail of the Tx link 505. A FIFO 802 is used to smooth the data flow from the HUB 402 to the PHY 408 by storing data packets for later transmission to the PHY 408. Preferably, the FIFO 802 is 4096 entries deep, large enough to hold the largest possible MTU, and 35-bits wide for 32-bits of data, and three-bits of status. Output data is stored in the FIFO 802 either in a store and forward mode, or when the Tx link 504 is busy transmitting other data to the PHY 408. The Tx link 504 is required to store a whole packet in the FIFO 802 whenever a packet is coming from a 4× receive port is destined to a 1× transmit port. In this case, the packet is received from the Hub 402 at a 4× data rate, stored in the FIFO 802 and forwarded to the PHY 408 at the 1× rate of the port. When receiving at 1× and transmitting at 4×, packet storage by the FIFO 802 is not required as the input VLs will store the complete packet prior sending it to the output port at the 4× output port rate.

When store and forward has been requested and/or when both transmit and receive ports are operating at 4× the data from such packets by-pass the FIFO 802. Where store-and-forward is not required, data from the Hub 402 may still be redirected to the FIFO 802 if the link is already busy transmission other data. Other data can come from another packet already in the FIFO 802, or from flow control packets from a flow controller (not shown), or because the link is transmitting a skip ordered-sequence. A mux 804 is provided to select between bypass data and data from the FIFO 802.

A CRC unit 806 monitors the output of the mux 804 and calculates a VCRC to be appended to the packet. The VCRC is appended by the mux 804 selecting the output of the CRC unit 806. The FIFO 802, mux 804 and CRC unit 806 are controlled by a Tx state machine 808.

In 1× mode, the Tx Link 504 must hold the word data stable for four cycles during which a PLI 810 grabs the appropriate byte to transmit one byte at a time. If data is a word is being received every cycle, the Tx link 504 stores the additional words in an output FIFO 802 to slow the output to one byte every four cycles. In 4× mode, the PLI 810 will re-order the words, the reverse of the Rx link 506, to allow for the start/end of packet delimiters.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A switch for use with an InfiniBand network, the switch comprising:
a crossbar that redirects packet based data based on a forwarding table;
at least one port that receives data from a network and selectively transfers that data to the crossbar at 1×, 4×, and 12× speeds; and
a state machine that controls the changing of the speed of operation of the port.

2. The switch, as set forth in claim 1, wherein state machine causes the port to strip start of packet delimiters from the packet prior to transferring the packet to the crossbar.

3. The switch, as set forth in claim 1, wherein state machine causes the port to strip end of packet delimiters from the packet prior to transferring the packet to the crossbar.

4. The switch, as set forth in claim 1, wherein the port further comprises:
a receive section receives data on a plurality of lanes, the receive section responsive to the state machine for receiving different data on each of the plurality of lanes in a cycle or for receiving the same data on each of the plurality of lanes in a cycle.

5. The switch, as set forth in claim 4, wherein the receive section passes through each of the plurality of lanes when receiving different data on each of the plurality of lanes in a cycle.

6. The switch, as set forth in claim 4, wherein the receive section sequential holds the value of each of all but one of the plurality of lanes until each lane has different data prior to passing the accumulated data through.

7. The switch, as set forth in claim 4, wherein the port further comprises:
a buffer that is loaded with data from the receive section and provides the data to the crossbar.

8. The switch, as set forth in claim 1, further comprising:
a controller to which the state machine is responsive for changing of the speed of operation of the port.

9. A method of changing the speed of operation to 1× in a switch for use with an InfiniBand network, the method comprising:
upon receipt of a SOP discarding all lanes of data;
in a second cycle registering a first byte of a first word;
in a third cycle registering a second byte of the first word while maintaining the first byte;
in a fourth cycle registering a third byte of the first word while maintaining the first and second byte;
in a fifth cycle receiving a fourth byte of the first word and combining the first, second, third and fourth byte in a buffer for transfer to a crossbar; and
in a sixth cycle in registering a first byte of a second word.

10. A method of changing the speed of operation to 4× in a switch for use with an InfiniBand network, the method comprising:
upon receipt of a SOP discarding all lanes of data and registering a first, second and third bytes of a first word;
in a second cycle receiving the fourth byte of a the first word, combining the first, second, third and fourth byte of the first word in a buffer for transfer to a crossbar and registering a first, second and third bytes of a second word; and
in a third cycle receiving the fourth byte of a the second word, combining the first, second, third and fourth byte of the second word in a buffer for transfer to a crossbar and registering a first, second and third bytes of a third word.

11. A switch for use with an InfiniBand network, the switch comprising:
a crossbar that redirects packet based data based on a forwarding table;
a least one port that receives data from the crossbar and selectively transfers that data to a network at 1×, 4×, and 12× speeds; and
a state machine that controls the changing of the speed of operation of the port.

12. The switch, as set forth in claim 11, further comprising:
a buffer to smooth data flow from the crossbar to the network.

13. The switch, as set forth in claim 12, further comprising:
a multiplexer that selects between the output of the crossbar and the output of the buffer to forward to the network based on the speed of the data coming from the crossbar and the speed at which data will be transferred to the network.

14. The switch, as set forth in claim 13, further comprising:
a CRC unit that creates a CRC based on the output of the multiplexer.

15. The switch, as set forth in claim 14, wherein the multiplexer can select the output of the CRC unit.

16. The switch, as set forth in claim 11, further comprising:
an interface that realigns data in the port prior to transfer to the network.
